(19) United States
(12) Patent Application Publication
(10) Pub. No.: US 2013/0294997 A1
(43) Pub. Date: Nov. 7, 2013

(54) METHOD FOR PRODUCING FLUORINE COMPOUND

(71) Applicants: Atsushi Fukunaga, Osaka-shi (JP); Shoichiro Sakai, Osaka-shi (JP); Koji Nitta, Osaka-shi (JP); Atsushi Yamaguchi, Osaka-shi (JP); Masatoshi Majima, Osaka-shi (JP); Shinji Inazawa, Osaka-shi (JP)

(72) Inventors: Atsushi Fukunaga, Osaka-shi (JP); Shoichiro Sakai, Osaka-shi (JP); Koji Nitta, Osaka-shi (JP); Atsushi Yamaguchi, Osaka-shi (JP); Masatoshi Majima, Osaka-shi (JP); Shinji Inazawa, Osaka-shi (JP)

(73) Assignee: SUMITOMO ELECTRIC INDUSTRIES, LTD., Osaka-shi, Osaka (JP)

(21) Appl. No.: 13/978,980

(22) PCT Filed: Jan. 13, 2012
(86) PCT No.: PCT/JP2012/050577

§ 371 Date: Jul. 10, 2013

(30) Foreign Application Priority Data
Jan. 14, 2011 (JP) 2011-006215

(51) Int. Cl. C01B 21/086

(52) U.S. Cl. CPC C01B 21/086
USPC 423/386

(57) ABSTRACT

KN(SO₂F)₂ is synthesized by adding HN(SO₂Cl)₂ dropwise to KF to form an intermediate product, and then allowing the intermediate product and KF to react with each other in an aqueous solvent.

### FIELD OF THE INVENTION

The present invention relates to a method for producing a fluorine compound in which a fluorine compound is synthesized from a chlorine compound.

### BACKGROUND OF THE INVENTION

A lithium ion secondary battery uses an electrolyte. In recent years, as the supporting salt of the electrolyte, attention has been given to imide salts such as LiN(SO₂F)₂. Whereas, as the molten salt of a molten salt battery, there is adopted KN(SO₂F)₂ or NaN(SO₂F)₂, or a mixture thereof. In order to operate the molten salt battery, the molten salt battery is required to be heated to the temperature at which the molten salt is molten. The melting point of KN(SO₂F)₂ or NaN(SO₂F)₂, or a mixture thereof is lower than the melting point of a conventional molten salt. For this reason, attention has been given thereto as the material for reducing the operating temperature of the molten salt battery.

Patent Document 1 discloses a method in which pyridine is used as a catalyst, and the reaction raw materials are fluorinated in an acetonitrile solvent to form KN(SO₂F)₂. Patent Document 2 discloses a method in which HN(SO₂Cl)₂ is fluorinated in a nitromethane solvent to form KN(SO₂F)₂. Non-Patent Document 1 discloses a method in which HN(SO₂Cl)₂ and KF are allowed to react with each other in a dichloromethane solvent to form KN(SO₂F)₂.

In order to control the price of the molten salt battery at a low level, it is necessary to suppress the production cost of KN(SO₂F)₂ or NaN(SO₂F)₂ for use in the molten salt battery. However, with the production methods disclosed in the respective documents, 48 to 72 hours is required until the completion of fluorination of HFSl(HN(SO₂Cl)₂). For this reason, the production cost of KN(SO₂F)₂ or NaN(SO₂F)₂ cannot be suppressed at a low level.

### PRIOR ART DOCUMENT

### Patent Document

Patent Document 1: Japanese Laid-Open Patent Publication No. 2007-182410

Patent Document 2: Japanese National Phase Laid-Open Patent Publication No. 2004-522681

### Non-Patent Document

Non-Patent Document 1: Z. Anorg. Allg. Chem. 2005, 631, 55-59

### SUMMARY OF THE INVENTION

It is an object of the present invention to provide a method for producing a fluorine compound, capable of providing a fluorine compound from a halide in a short time.

In order to solve the problem, in accordance with a first aspect of the present invention, there is provided a method for producing a fluorine compound, in which a halogen element of a halogen compound represented by the following expression (1) is substituted with fluorine, to thereby synthesize a fluorine compound represented by the following expression (2). With the production method, the halogen compound and an alkali metal fluoride MF which is a fluoride of an alkali metal M are allowed to react with each other under solvent-free conditions to form an intermediate product; and then the intermediate product and the alkali metal fluoride MF are allowed to react with each other in a polar solvent.

HN(SO₂X¹) (SO₂X²) (1)

MN(SO₂F)₂ (2)

where X¹ and X² each independently represent any element of Cl, Br, and I; and the alkali metal M represents any of Li, Na, K, Rb, and Cs.

In the related art, in order to obtain a fluorine compound, HN(SO₂Cl)₂ and an alkali metal fluoride are allowed to react with each other in a solvent such as dichloromethane. However, the reaction rate of HN(SO₂Cl)₂ and an alkali metal fluoride is slow. This is due to the following fact: a fluoride is not dissolved in dichloromethane, and hence HN(SO₂Cl)₂ and the alkali metal fluoride can react with each other only on the surface of the fluoride. On the other hand, it can be also considered that HN(SO₂Cl)₂ and an alkali metal fluoride are allowed to react with each other in a solvent for dissolving a fluoride therein. However, even when HN(SO₂Cl)₂ and an alkali metal fluoride are allowed to react with each other in acetonitrile, the reaction rate does not increase. Alternatively, it can be also considered that HN(SO₂Cl)₂ and an alkali metal fluoride are allowed to react with each other in an aqueous solvent for dissolving an alkali metal fluoride therein. However, HN(SO₂Cl)₂ reacts with water to be hydrolyzed. For this reason, the objective product cannot be synthesized.

The present inventors found the following: HN(SO₂X¹) (SO₂X²) and an alkali metal fluoride MF are allowed to react with each other under solvent-free conditions, so that one halogen element is substituted with fluorine; and the reaction is completed in a short time. Further, the present inventors found the following: the product resulting from the reaction is MN(SO₂X) (SO₂F); and MN(SO₂X) (SO₂F) and the alkali metal fluoride MF are allowed to react with each other in a polar solvent, which can provide MN(SO₂F)₂ which is the objective product. Further, the present inventors also found that the synthesis method is completed in a shorter time as compared with a related-art synthesis method.

In the related art, in one step, HN(SO₂Cl)₂ and KF are allowed to react with each other under prescribed conditions, thereby to form KN(SO₂F)₂. In contrast, in accordance with the method of the present invention, in a first step, one halogen element of HN(SO₂X¹) (SO₂X²) is substituted with fluorine; and in a second step, the other halogen element is substituted with fluorine. In accordance with such a two-stage step, first, in the first step, HN(SO₂X¹) (SO₂X²) is converted into an alkali metal salt, thereby to eliminate HN(SO₂X¹) (SO₂X²). As a result, in the second step, it becomes possible to use water which tends to dissolve the alkali metal fluoride MF.

In the production method of the fluorine compound, it is preferable that the moisture is removed from the alkali metal fluoride before the halogen compound and the alkali metal fluoride are allowed to react with each other.

HN(SO₂X¹) (SO₂X²) reacts with water to be hydrolyzed, resulting in the formation of a by-product. In accordance with the invention, the moisture is removed from the alkali metal fluoride, which enables suppression of the formation of the by-product due to hydrolysis.

In the production method of a fluorine compound, the polar solvent is preferably a protic polar solvent.

The alkali metal fluoride (MN(SO₂X¹) (SO₂F)) dissolves more in a protic polar solvent than in an aprotic polar solvent. For this reason, in accordance with the invention, it is possible to promote the reaction between (MN(SO₂X¹) (SO₂F) and the alkali metal fluoride MF.

In order to solve the problem, in accordance with a second aspect of the present invention, there is provided a method for producing a fluorine compound, in which one halogen element of a halogen compound represented by the following expression (3) is substituted with fluorine, to thereby synthesize a fluorine compound represented by the following expression (4). With the production method, the halogen compound and an alkali metal fluoride MF which is a fluoride of an alkali metal M are allowed to react with each other under solvent-free conditions.

HN(SO₂X)₂ (3)

MN(SO₂X) (SO₂F) (4)

where X represents any element of Cl, Br, and I; and

the alkali metal M represents any of Li, Na, K, Rb, and Cs.

In accordance with this invention, by effecting the reaction of the first step in the invention, it is possible to obtain MN(SO₂X) (SO₂F) from HN(SO₂X)₂. According to the method, MN(SO₂X) (SO₂F) can be synthesized in a shorter time as compared with a conventional method.

In order to solve the problem, in accordance with a third aspect of the present invention, there is provided a method for producing a fluorine compound, in which a halogen element other than fluorine of a halogen compound represented by the following expression (4) is substituted with fluorine, to thereby synthesize a fluorine compound represented by the following expression (5). With the production method, the halogen compound and an alkali metal fluoride MF which is a fluoride of an alkali metal M are allowed to react with each other in a polar solvent.

MN(SO₂X) (SO₂F) (4)

MN(SO₂F)₂ (5)

where X represents any element of Cl, Br, and I; and the alkali metal M represents any of Li, Na, K, Rb, and Cs.

In accordance with this invention, by effecting the reaction of the second step in the invention, it is possible to obtain MN(SO₂F)₂. Incidentally, the production method of MN(SO₂X) (SO₂F) which is the raw material is not limited to the production method in which the alkali metal fluoride MF and HN(SO₂X)₂ are allowed to react with each other for formation thereof.

### BRIEF DESCRIPTION OF THE DRAWINGS

FIG. 1(A) is a ¹⁹F-NMR spectral diagram of KN(SO₂F)₂; FIG. 1(B) is a ¹⁹F-NMR spectral diagram immediately after adding water to an intermediate product A; and FIG. 1(C) is a ¹⁹F-NMR spectral diagram after a lapse of 8 hours from addition of water to the intermediate product A.

### DETAILED DESCRIPTION OF THE PREFERRED EMBODIMENTS

Referring to the expression (A), a description will be given to the summary of the production method of KN(SO₂F)₂ synthesized from HN(SO₂Cl)₂.

HN(SO₂Cl)₂ is formed by a conventional production method. Then, HN(SO₂Cl)₂ is added dropwise to an excess powdery KF. When KF contains moisture, water and HN(SO₂Cl)₂ may react with each other to undergo hydrolysis. For this reason, before dropwise addition of HN(SO₂Cl)₂ to KF, the moisture is previously removed from KF. Then, HN(SO₂Cl)₂ and KF are allowed to react with each other to form KN(SO₂Cl) (SO₂F) and HCl. The reaction is effected under solvent-free conditions, and hence is completed in about two to three minutes. The product formed by adding HN(SO₂Cl)₂ dropwise to powdery KF, namely, the product including KN(SO₂Cl) (SO₂F) and KF is referred to as an intermediate product A.

Then, water as a solvent is added to the intermediate product A. KN(SO₂Cl) (SO₂F) does not react with water, so that the product resulting from hydrolysis is not formed. On the other hand, KF is dissolved in water to be ionized. Accordingly, Cl of KN(SO₂Cl) (SO₂F) is substituted with fluorine. This results in the formation of KN(SO₂F)₂ and KCl. The reaction is completed in about 6 to 7 hours, and is almost completed after a lapse of 12 hours. Subsequently, the reaction system is reduced in pressure, so that water is evaporated from the reactant. Further, the reactant is evaporated, resulting in KN(SO₂F)₂.

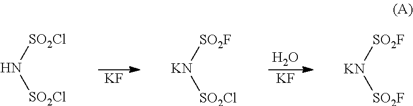

<Synthesis of HN(SO₂Cl)₂>

Then, a description will be given to the synthesis method of HN(SO₂Cl)₂ which is the raw material for KN(SO₂F)₂. The synthesis method of HN(SO₂Cl)₂ is not limited to the following method.

First, sulfamic acid, chlorosulfonic acid, and thionyl chloride are mixed in an inert atmosphere so as to be in a mole ratio of 1.0:1.0:2.4. Then, the mixed solution is heated, and a part of the distillate is refluxed. Then, from the time point at which the temperature reaches 80° C., thionyl chloride boils, and the reaction starts. The reaction is continued at a temperature of 130° C. for about 8 hours. After a lapse of 8 hours, a calcium chloride tube is attached at the vapor outlet port of the reaction system so as to prevent the moisture from entering the reaction system. Then, the reaction system is cooled, resulting in a liquid intermediate product B. The intermediate product B includes HN(SO₂Cl)₂ which is the objective product.

Then, in order to extract HN(SO₂Cl)₂ from the intermediate product B, heating is performed at a temperature of 130° C. under reduced pressure (650 Pa or less), thereby to volatilize the remaining thionyl chloride. Further, at the time point of completion of volatilization of thionyl chloride, the reaction system is further heated, and distilled at a temperature of about 130° C. As a result, HN(SO₂Cl)₂ which is the objective product is extracted.

<Synthesis of KN(SO₂F)₂>

Then, a description will be given to the synthesis method of KN(SO₂F)₂.

In the first step, KF in a powder form is previously dried, so that the moisture is removed from KF. Then, HN(SO₂Cl)₂ is previously heated to 37° C. or more to be in a liquid form, and is added dropwise to KF. The amount of HN(SO₂Cl)₂ to be added dropwise to 2.5 to 3.0 mol of KF is 1.0 mol. In this case, KF is set in an excess amount relative to HN(SO₂Cl)₂. Namely, the amounts of HN(SO₂Cl)₂ and KF are determined so that all HN(SO₂Cl)₂ reacts with KF.

KF and HN(SO₂Cl)₂ react exothermically with each other, resulting in the formation of HCl. When HCl ceases to be formed, or heat ceases to be generated, the reaction terminates. The reaction forms KN(SO₂Cl) (SO₂F). In the reaction, KN(SO₂F)₂ is not formed. The reaction is completed in two to three minutes. The reason why the reaction time becomes short can be considered as follows: KF and HN(SO₂F)₂ do not come in contact with each other in the solvent, but KF and HN(SO₂F)₂ come in direct contact with each other.

In the second step, water is added to the intermediate product A obtained in the first step. The amount of water is set at an amount about three times the volume of KF. Then, the aqueous solution is stirred at room temperature for 12 hours. At this step, stirring may be performed with the temperature set equal to or more than room temperature.

Then, the aqueous solution is reduced in pressure, and dried, resulting in a mixed powder of KF, KCl, and KN(SO₂F)₂. KN(SO₂F)₂ is separated in the following manner. For example, based on the fact that the melting point of KN(SO₂F)₂ is lower than those of KF and KCl, KN(SO₂F)₂ can be separated. Specifically, the mixed powder is heated to a temperature at which KN(SO₂F)₂ melts, and to a temperature at which KF and KCL do not melt. Thus, KN(SO₂F)₂ is allowed to melt, and KF and KCl are allowed to remain as solid matters. Then, by a centrifugal separator or a filtering device, the mixture of the molten matter and the solid matters is separated into KN(SO₂F)₂, and KF and KCl.

Alternatively, it is also possible to separate KN(SO₂F)₂ based on the difference in solubility to various solvents of KF, KCl, and KN(SO₂F)₂. Specifically, there can be used the method (recrystallization method) in which a solvent in which KF and KCl are soluble, and KN(SO₂F)₂ is hardly soluble is selected, and KN(SO₂F)₂ is precipitated in the solvent. Still alternatively, KN(SO₂F)₂, and KF and KCl can be separated using a column chromatography device.

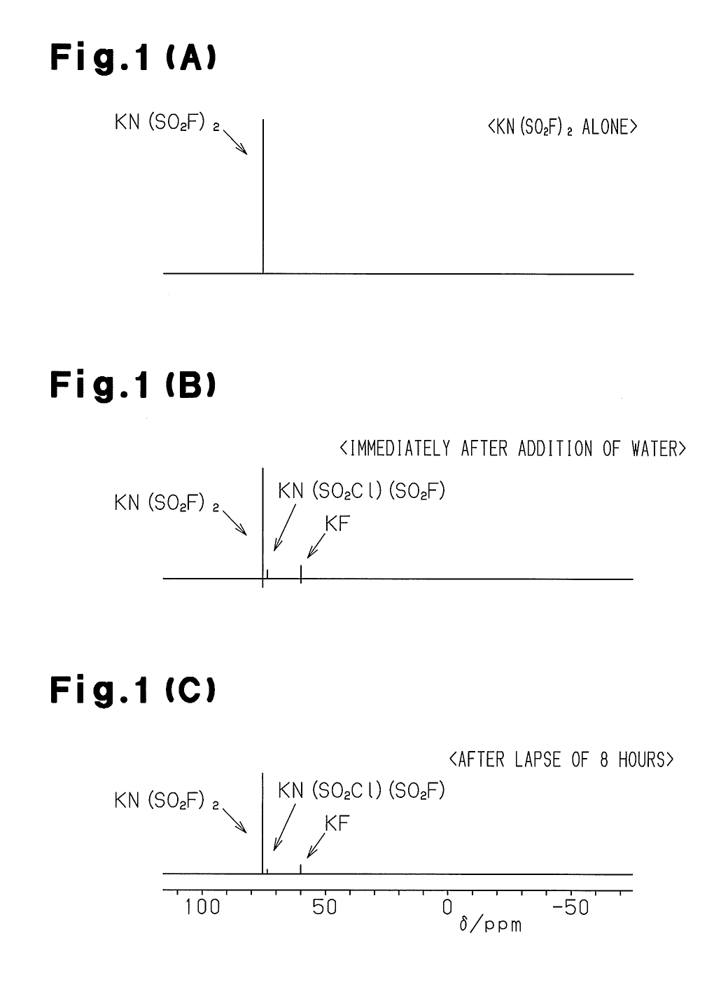

The formation of KN(SO₂F)₂ will be described by reference to the ¹⁹F-NMR spectra of FIG. 1.

As shown in FIG. 1(A), the ¹⁹F-NMR spectrum of KN(SO₂F)₂ alone has one peak at 77 δ/ppm.

FIG. 1(B) shows the ¹⁹F-NMR spectra of the reactant and the product at the initial stage in the second step, namely, immediately after addition of water to the intermediate product A of the first step. At this period, there can be observed spectra of KN(SO₂F)₂, KN(SO₂Cl) (SO₂F), and KF. Namely, it is shown that KN(SO₂F)₂ is formed immediately after addition of water in the second step.

FIG. 1(C) shows the ¹⁹F-NMR spectra of the reactants upon a lapse of 8 hours after addition of water. At this period, the corresponding spectrum of KN(SO₂Cl) (SO₂F) mostly disappears. Namely, after a lapse of 8 hours, the reaction of fluorination of KN(SO₂Cl) (SO₂F) is nearly completed.

In accordance with the present embodiment, it is possible to exert the following advantageous effects.

(1) HN(SO₂Cl)₂ is added dropwise to KF to form the intermediate product A. Then, the intermediate product A and KF are allowed to react with each other in an aqueous solvent to synthesize KN(SO₂F)₂. In accordance with this method, it is possible to synthesize KN(SO₂F)₂ in a shorter time as compared with a conventional method.

(2) HN(SO₂Cl)₂ reacts with water to be hydrolyzed, resulting in the formation of a by-product. In this regard, in accordance with the present invention, before adding HN(SO₂Cl)₂ dropwise to KF, the moisture is removed from KF. For this reason, it is possible to suppress the formation of the by-product due to hydrolysis.

(3) In the second step, water is used as a solvent. In accordance with this method, a larger amount of KF can be dissolved in water than when a nonpolar solvent is used as a solvent. For this reason, it is possible to promote the reaction between KN(SO₂Cl) (SO₂F) and fluorine.

Incidentally, the embodiment of the present invention may be changed as follows.

In the embodiment, in the second step, water was used as the solvent for dissolving the intermediate product A therein. However, a given polar solvent may be used. For example, ethanol or acetonitrile may be used.

In the embodiment, with HN(SO₂Cl)₂ as a raw material, KN(SO₂F)₂ which was the objective product was synthesized. However, HN(SO₂X¹) (SO₂X²) may be used as a raw material. Herein, X¹ and X² each independently represent any element of Cl, Br, and I.

Alternatively, with KN(SO₂X) (SO₂F) as a raw material, KN(SO₂F)₂ which was the objective product may be synthesized. Herein, X represents any element of Cl, Br, and I. In this case, the same synthesis method as in the second step is used. The synthesis method of KN(SO₂X) (SO₂F) is not limited to the synthesis method by the first step.

In the embodiment, the synthesis method of KN(SO₂F)₂ was described, and MN(SO₂F)₂ may be synthesized by the same method. Herein, M represents an alkali metal, namely, any of Li, Na, K, Rb, and Cs. Namely, MN(SO₂F)₂ is synthesized by the step according to the first step and the second step, using HN(SO₂X)₂ or HN(SO₂X¹) (SO₂X²) as a raw material. Whereas, MN(SO₂F)₂ is synthesized by the step according to the second step using MN(SO₂X) (SO₂F) as a raw material. Note that an alkali metal fluoride corresponding to the alkali metal salt which is the objective product is used in place of KF in each step as the fluorine source.

In the embodiment, KN(SO₂F)₂ was assumed to be the objective product. However, the alkali metal salt formed by the first step, namely, KN(SO₂X) (SO₂F) may be assumed to be the objective product to be synthesized. Herein, X represents any element of Cl, Br, and I. The production method of KN(SO₂X) (SO₂F) is the same as that of the first step.

Further, similarly, LiN(SO₂X)(SO₂F), NaN(SO₂X) (SO₂F), RbN(SO₂X) (SO₂F), and CsN(SO₂X) (SO₂F) may be synthesized by the method according to the first method. Note that an alkali metal fluoride corresponding to the alkali metal salt which is the objective product is used in place of KF for use in the first step.

1. A method for producing a fluorine compound, in which a halogen element of a halogen compound represented by the following expression (1) is substituted with fluorine, to thereby synthesize a fluorine compound represented by the following expression (2), the method comprising: allowing the halogen compound and an alkali metal fluoride MF which is a fluoride of an alkali metal M to react with each other under solvent-free conditions to form an intermediate product, and then allowing the intermediate product and the alkali metal fluoride MF to react with each other in a polar solvent,
HN(SO2X1)(SO2X2) (1)
MN(SO2F)2 (2)
where X1 and X2 each independently represent any element of Cl, Br, and I; and
the alkali metal M represents any of Li, Na, K, Rb, and Cs.

2. The method for producing a fluorine compound according to claim 1,
wherein, before allowing the halogen compound and the alkali metal fluoride to react with each other, moisture is removed from the alkali metal fluoride.

3. The method for producing a fluorine compound according to claim 1, wherein the polar solvent is a protonic polar solvent.

4. A method for producing a fluorine compound, in which one halogen element of a halogen compound represented by the following expression (3) is substituted with fluorine, to thereby synthesize a fluorine compound represented by the following expression (4), the method comprising:
allowing the halogen compound and an alkali metal fluoride MF which is a fluoride of an alkali metal M to react with each other under solvent-free conditions,
HN(SO2X)2 (3)
MN(SO2X)(SO2F) (4)
where X represents any element of Cl, Br, and I; and
the alkali metal M represents any of Li, Na, K, Rb, and Cs.

5. A method for producing a fluorine compound, in which a halogen element other than fluorine of a halogen compound represented by the following expression (4) is substituted with fluorine, to thereby synthesize a fluorine compound represented by the following expression (5), the method comprising:
allowing the halogen compound and an alkali metal fluoride MF which is a fluoride of an alkali metal M to react with each other in a polar solvent,
MN(SO2X)(SO2F) (4)
MN(SO2F)2 (5)
where X represents any element of Cl, Br, and I; and
the alkali metal M represents any of Li, Na, K, Rb, and Cs.
